(19) United States
(12) Patent Application Publication
(10) Pub. No.: US 2022/0156127 A1
(43) Pub. Date: May 19, 2022

(54) MULTI-THREADS TRACKING METHOD, MULTI-THREADS TRACKING SYSTEM FOR OPERATING SYSTEM AND ELECTRONIC DEVICE USING THE SAME

(71) Applicant: INDUSTRIAL TECHNOLOGY RESEARCH INSTITUTE, Hsinchu (TW)

(72) Inventors: Wei-En LIANG, New Taipei City (TW); Tzu-Lin WANG, New Taipei City (TW)

(73) Assignee: INDUSTRIAL TECHNOLOGY RESEARCH INSTITUTE, Hsinchu (TW)

(21) Appl. No.: 17/135,224

(22) Filed: Dec. 28, 2020

(30) Foreign Application Priority Data
Nov. 18, 2020 (TW) 109140328

(51) Int. Cl. G06F 9/52; G06F 9/54

(52) U.S. Cl. CPC G06F 9/52; G06F 9/546

(57) ABSTRACT

A multi-threads tracking method, a multi-threads tracking system for an operating system and an electronic device using the same are provided. The multi-threads tracking method of the operating system includes the following steps. At least two message queue access events among two threads and one message queue are intercepted. A thread identification, a process identification, an input value and a return value of each of the message queue access events are recorded. Based on a determination of a relationship among the thread identifications, the process identifications, the input values, and the return values of the message queue access events, an In-Process dependency among the threads and the message queue is established.

This application claims the benefit of Taiwan application Serial No. 109140328, filed Nov. 18, 2020, the disclosure of which is incorporated by reference herein in its entirety.

### TECHNICAL FIELD

The disclosure relates in general to a multi-threads tracking method, a multi-threads tracking system for an operating system and an electronic device using the same.

### BACKGROUND

With the development of information technology, the application of information technology has become more and more extensive, and the architecture of the operation system and application has become more and more complex. In the operation of the operation system, if each service execution trace can be traced, the root cause of the service abnormality can be instantly found.

However, in some physical machine applications, multiple threads may access the same message queue. For example, the front-end frameworks of many mainstream web pages have an architecture that multiple threads access to the same message queue. Currently proposed technology cannot trace the service execution trace under this architecture. Therefore, researchers are working hard to study how to track the multi-thread relationship of the operation system for this architecture.

### SUMMARY

The disclosure is directed to a multi-threads tracking method, a multi-threads tracking system for an operating system and an electronic device using the same.

According to one embodiment, a multi-threads tracking method for an operation system is provided. The multi-threads tracking method includes the following steps. At least two message queue access events among two threads and one message queue are intercepted. A thread identification, a process identification, an input value and a return value of each of the message queue access events are recorded. An In-Process dependency among the threads and the message queue is established according to a determination of a relationship among the thread identifications, the process identifications, the input values and the return values of the message queue access events.

According to another embodiment, a multi-threads tracking system for an operation system is provided. The multi-threads tracking system includes an intercepting unit, a recording unit and a matching unit. The intercepting unit is configured to intercept at least two message queue access events among two threads and one message queue. The recording unit is configured to record a thread identification, a process identification, an input value and a return value of each of the message queue access events. The matching unit is configured to establish an In-Process dependency among the threads and the message queue according to a determination of a relationship among the thread identifications, the process identifications, the input values and the return values of the message queue access events.

According to an alternative embodiment, an electronic device comprising a processor is provided. The processor is configured to load a program code for performing a multi-threads tracking method for an operation system. The multi-threads tracking method comprises the following steps. At least two message queue access events among two threads and one message queue are intercepted. A thread identification, a process identification, an input value and a return value of each of the message queue access events are recorded. An In-Process dependency among the threads and the message queue is established according to a determination of a relationship among the thread identifications, the process identifications, the input values and the return values of the message queue access events.

### BRIEF DESCRIPTION OF THE DRAWINGS

FIG. 1 illustrates that a plurality of threads access the same message queue.

FIG. 2 shows a multi-threads tracking system for an operation system according to one embodiment.

FIG. 3 shows a flowchart of the multi-threads tracking method for the operation system according to one embodiment.

FIG. 4 shows a flowchart of the multi-threads tracking method for the operation system according to one embodiment.

FIG. 5 illustrates the steps in FIG. 4.

FIG. 6 shows a flowchart of the multi-threads tracking method for the operation system according to one embodiment.

FIG. 7 illustrates the steps in FIG. 6.

FIG. 8 shows a flowchart of the multi-threads tracking method for the operation system according to one embodiment.

FIG. 9 illustrates the steps in FIG. 8.

FIGS. 10A and 10B show a flowchart of the multi-threads tracking method for the operation system according to one embodiment.

FIG. 11 illustrates the steps in FIGS. 10A and 10B.

FIG. 12 shows the multi-threads tracking method for the operation system according to another embodiment.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

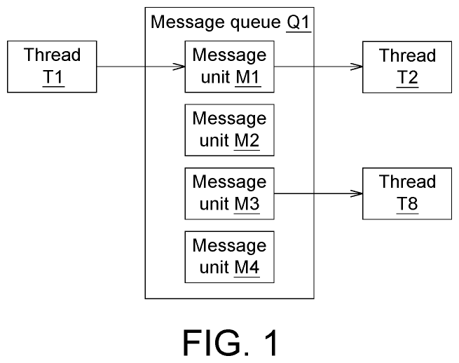

Refer please to FIG. 1, which illustrates that a plurality of threads access the same message queue. In a multi-thread architecture, the message queue Q1 in an application stores a plurality of message units M1, M2, M3, M4. A thread T1, a thread T2 and a thread T8 may access the message queue Q1 at the same time. Traditionally, it is impossible to analyze the dependencies of the thread T1, the thread T2 and the thread T8, which makes it impossible to track the service execution trace.

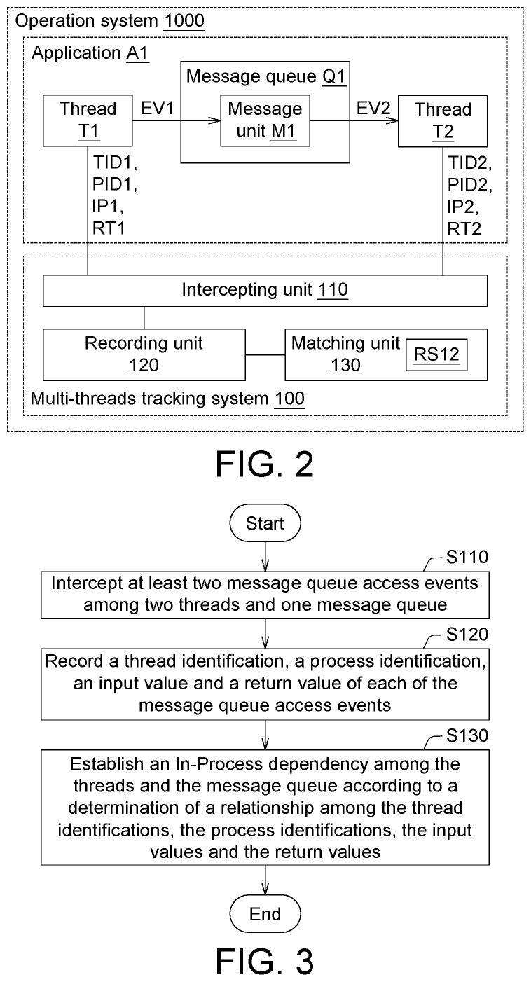

Refer please to FIG. 2, which shows a multi-threads tracking system 100 for an operation system 1000 according to one embodiment. The multi-threads tracking system 100 is, for example, a core system of the operation system 1000. The multi-threads tracking system 100 includes an intercepting unit 110, a recording unit 120 and a matching unit 130. The function of each component of the multi-threads tracking system 100 is summarized as follows. The intercepting unit 110 is configured to intercept messages and communication content. The recording unit 120 is configured to record various information. The matching unit 130 is configured to concatenate various information to determine the dependency of threads. The intercepting unit 110 and/or the matching unit 130 are/is, for example, a circuit, a chip, a circuit board, a storage device storing program code. The recording unit 120 is, for example, a memory, a hard disk or a cloud storage center. The following is a detailed description of the operation of the above components with a flowchart.

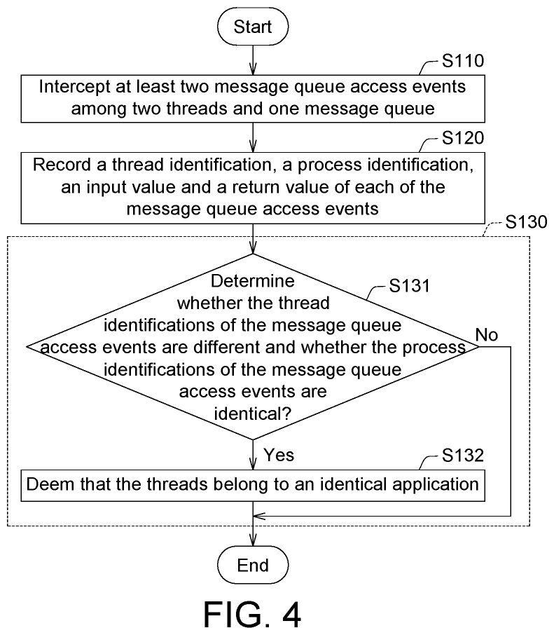

Refer please to FIG. 3, which shows a flowchart of the multi-threads tracking method for the operation system 1000 according to one embodiment. In the present disclosure, the multi-threads tracking method can be executed through the multi-threads tracking system 100 in FIG. 2 above; or, the multi-threads tracking method can be executed by a processor of an electronic device loaded with program code. In step S110, the intercepting unit 110 intercepts two message queue access events EV1, EV2 among two threads T1, T2 and one message queue Q1. The message queue access event EV1 is, for example, a request for storing the message units M1, M2, M3, M4 in the message queue Q1. The message queue access event EV2 is, for example, a request for reading the message units M1, M2, M3, M4 in the message queue Q1. In this step, the intercepting unit 110 executes intercepting through, but not limited to, the User Statically-Defined Tracing (USDT). Because the occurrence time of the message queue access events EV1 and EV2 is not consistent, the intercepting unit 110 will not intercept the message queue access events EV1, EV2 at the same time. The intercepting unit 110 monitors the transmission among the threads T1, T2 and the message queue Q1 at any time, and intercepts once any message queue access event occurs.

Then, in step S120, the recording unit 120 records thread identifications TID1, TID2, process identifications PTD1, PID2, input values IP1, IP2 and return values RT1, RT2 of the message queue access events EV1, EV2. The thread identifications TID1, TID2 represent the threads. The process identifications PID1, PID2 represent the processing procedures. Generally speaking, the processing procedures of the same application are the same. Each of the input values IP1, IP2 is a storage content in a request for storing a message unit in the message queue, or an address in a request for reading a message unit in the message queue. The return values RT1 and RT2 are the storage result of the request for storing the message unit in the message queue or the read content of the request for reading the message unit in the message queue.

Afterwards, in step S130, the matching unit 130 establishes an In-Process dependency RS12 among the threads T1, T2 and the message queue Q1 according to a determination of a relationship among the thread identifications TID1, TID2, the process identifications PID1, PID2, the input values IP1, IP2 and the return values RT1, RT2. The In-Process dependency RS12 includes whether the threads T1 and T2 belong to the same application A1; and whether there is a series of actions among the threads T1, T2 and the message queue Q1 to store and access the same message unit M1. The descriptions for these two situations are as follows.

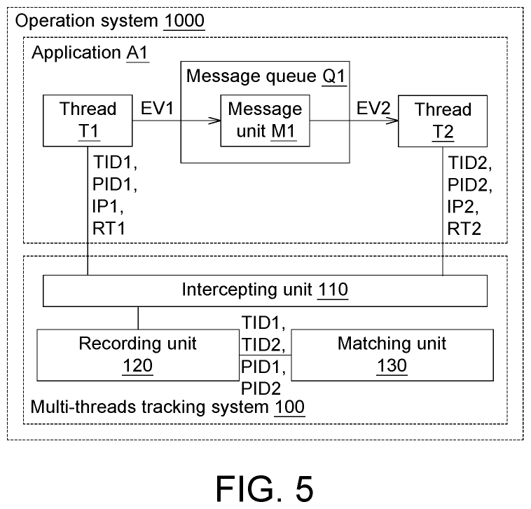

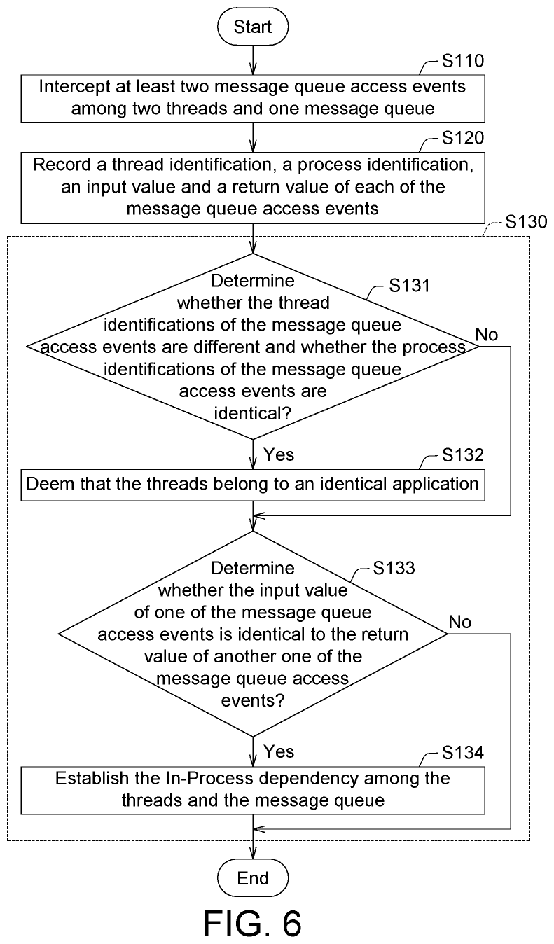

Please refer to FIGS. 4 to 5. FIG. 4 shows a flowchart of the multi-threads tracking method for the operation system 1000 according to one embodiment. FIG. 5 illustrates the steps in FIG. 4. Since the operation system 1000 may contain multiple applications, so multiple threads may belong to different applications. The step S130 of the multi-threads tracking method in FIG. 4 can confirm whether these threads belong to the same application when establishing the In-Process dependency RS12.

The steps S110, S120 are the same as previously described, and will not be repeated here. The step S130 includes steps S131 and S132. In the step S131, the matching unit 130 determines whether the thread identifications TID1, TID2 of the message queue access events EV1, EV2 are different and whether the process identifications PID1, PID2 of the message queue access events EV1, EV2 are identical. If the thread identifications TID1, TID2 of the message queue access events EV1, EV2 are different and the process identifications PID1, PID2 of the message queue access events EV1, EV2 are identical, the process proceeds to the step S132.

In the step S132, the matching unit 130 deems that the threads T1, T2 belong to the same application. As shown in FIG. 5, the process identifications PID1, PID2 are identical, so the threads T1, T2 and the message queue access events EV1, EV2 belong the same application Al.

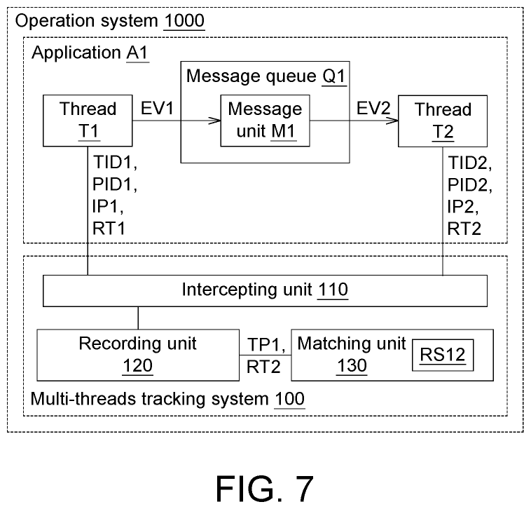

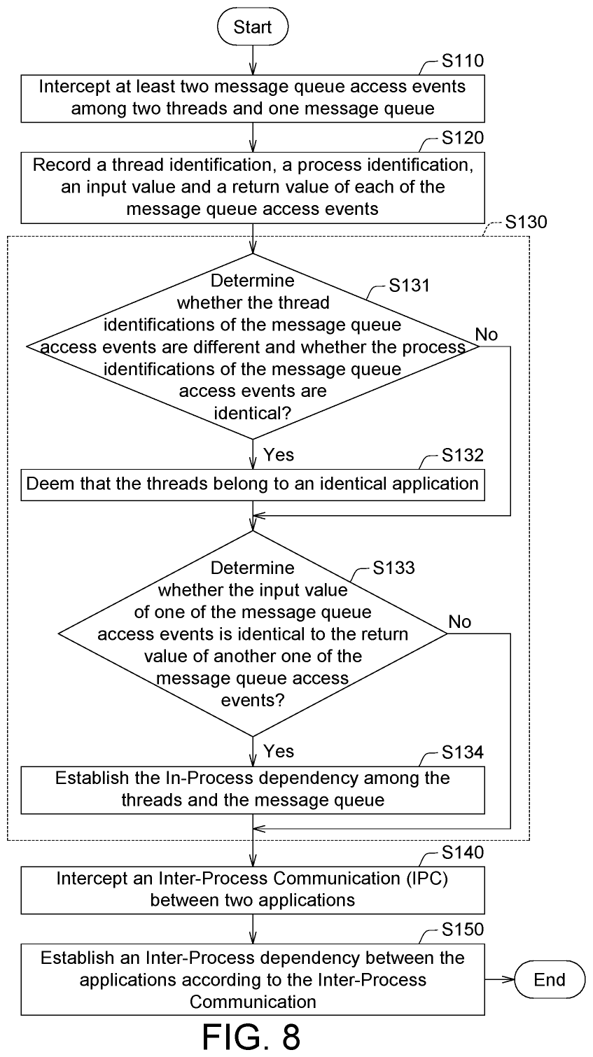

Refer please to FIGS. 6 to 7. FIG. 6 shows a flowchart of the multi-threads tracking method for the operation system 1000 according to one embodiment. FIG. 7 illustrates the steps in FIG. 6. After determining that the threads T1 and T2 belong to the same application A1, the step S130 further includes steps S133 and S134 to confirm whether there is a series of actions among the threads T1, T2 and the message queue Q1 to store and access the same message unit M1.

In the step S133, the matching unit 130 determines whether the input value IP1 of the message queue access event EV1 and the return value RT2 of the message queue access event EV2 are identical. If the input value IP1 of the message queue access event EV1 and the return value RT2 of the message queue access event EV2 are identical, the process proceeds to the step S134.

In the step S134, the matching unit 130 establishes the In-Process dependency RS12 among the threads T1, T2 and the message queue Q1. That is to say, after the steps S131 to S134, the matching unit 130 confirms that the threads T1 and T2 belong to the same application A1, and confirms that there is a series of actions among the threads T1, T2 and the message queue Q1 to store and access the same message unit M1, so the In-Process dependency RS12 among the threads T1, T2 and the message queue Q1 can be established.

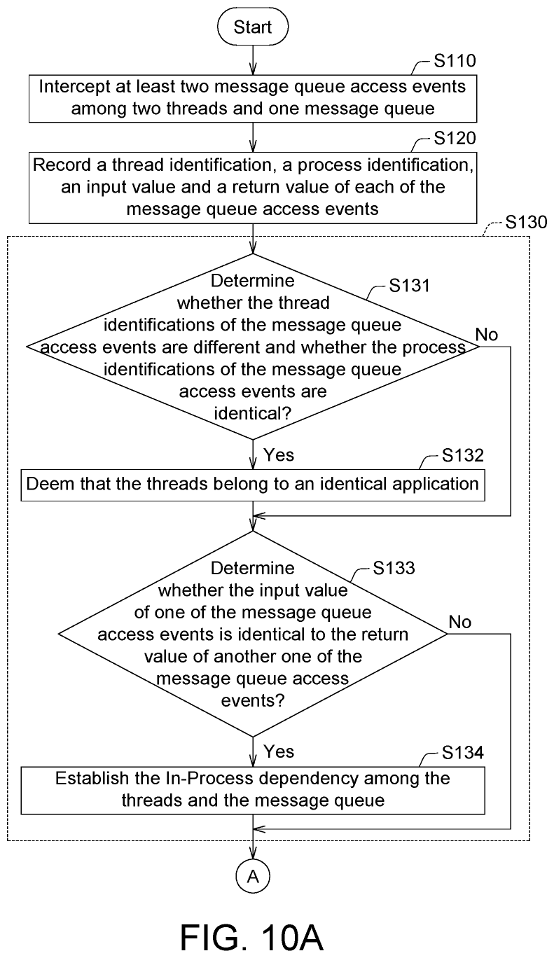

The operation system 1000 may include a plurality of applications A1, A2, . . . (the application A2 is shown in FIG. 9). One service request can be executed through several applications A1, A2, . . . To track the service execution trace, an Inter-Process dependency RS23 (shown in FIG. 9) is needed to be further established. The following further explains how to establish the Inter-Process dependency RS23.

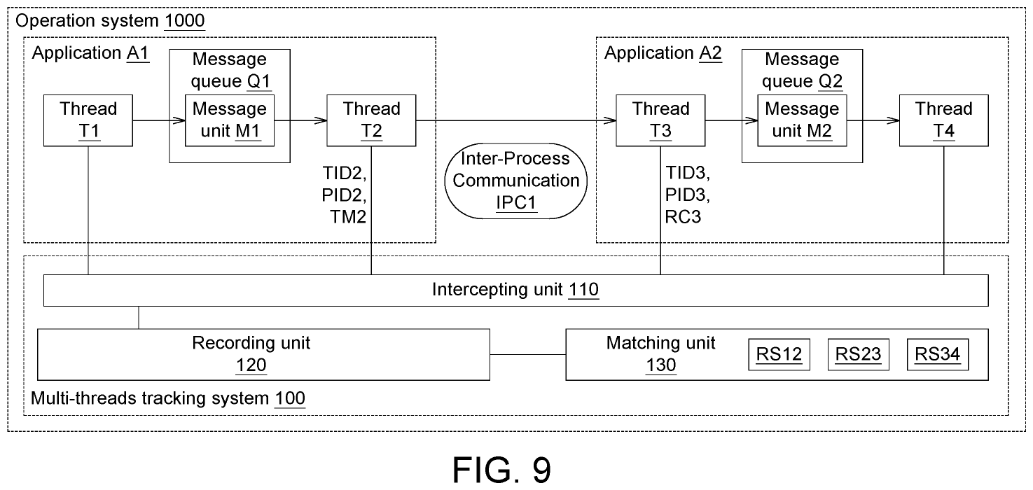

Refer please to FIGS. 8 to 9. FIG. 8 shows a flowchart of the multi-threads tracking method for the operation system 1000 according to one embodiment. FIG. 9 illustrates the steps in FIG. 8. After establishing the In-Process dependency RS12, the multi-threads tracking method includes steps S140 to S150.

In the step S140, the intercepting unit 110 intercepts an Inter-Process Communication (IPC) between the two applications A1, A2. The Inter-Process Communication IPC1 is a technology or method for transmitting data or signals between two processes or threads. The Inter-Process Communication IPC1 is used to enable different threads to access resources and coordinate work with each other.

Next, in the step S150, the matching unit 130 establishes the Inter-Process dependency RS23 among the applications A1, A2 according to the Inter-Process Communication IPC1. For example, the matching unit 130 may deem that the Inter-Process dependency RS23 can be established between the applications A1, A2 according to the thread identification TID2, the process identification PID2 and the transmission value TM2 of the thread T2, and the thread identification TID3, the process identification PID3 and the receiving value RC3 of the thread T3 in the Inter-Process Communication IPC1.

For the application A2, the multi-threads tracking system 100 can also apply the method described in the embodiment of FIG. 6 to establish the In-Process dependency RS34 among the threads T3, T4 and the message queue Q2. The method for establishing the In-Process dependency RS34 is similar to the method for establishing the In-Process dependency RS12, so the description will not be repeated here.

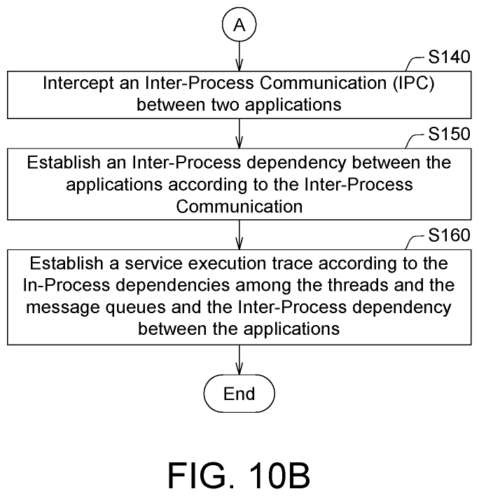

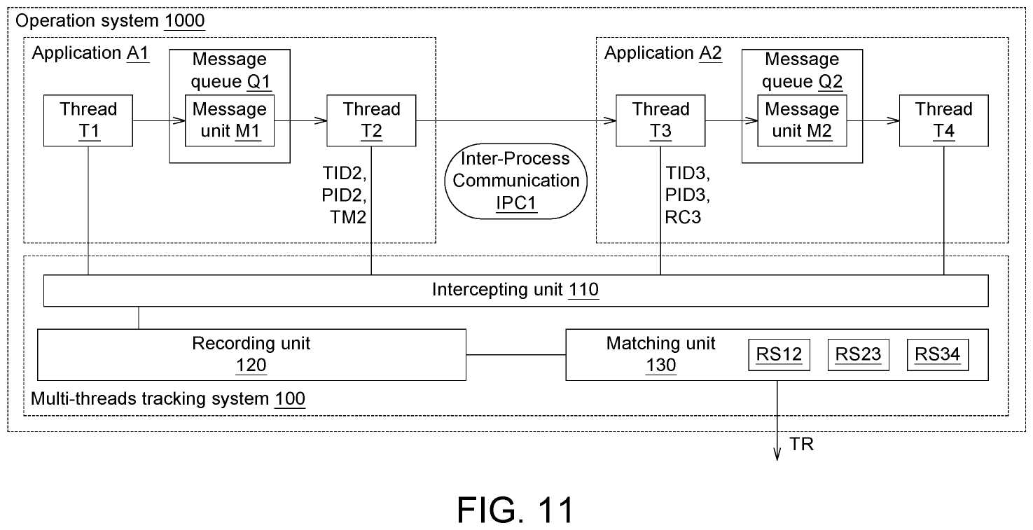

Refer please to FIGS. 10 to 11. FIGS. 10A and 10B show a flowchart of the multi-threads tracking method for the operation system 1000 according to one embodiment. FIG. 11 illustrates the steps in FIGS. 10A and 10B. After establishing the In-Process dependencies RS12, RS34 and the Inter-Process dependency RS23, the multi-threads tracking method further includes step S160.

In the step S160, the matching unit 130 establishes a service execution trace TR according to the In-Process dependencies RS12, RS34 among the threads T1, T2, T3, T4 and the message queues Q1, Q2 and the Inter-Process dependency RS23 between the applications A1, A2. The service execution trace TR, for example, follows the trajectory of the In-Process dependency RS12, the Inter-Process dependency RS23 and the In-Process dependency RS34 in series. The service execution trace TR in FIG. 11 is the trajectory of the thread T1, the message queue Q1, the thread T2, the thread T3, the message queue Q2 and the thread T4 in order. In the service execution trace TR, the traces between the applications and within applications can be obtained. In this way, through the service execution trace TR of each service request, the root cause of the service abnormality can be found effectively and instantly.

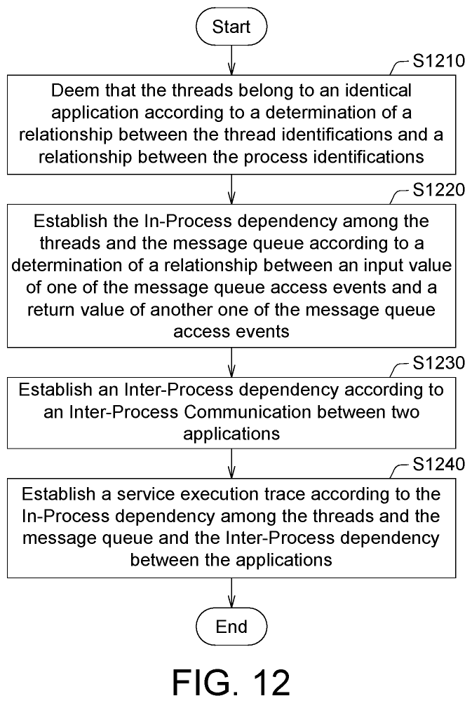

In another embodiment, the establishment of the service execution trace TR can be simplified to the process shown in FIG. 12. Refer please to FIG. 12, which shows the multi-threads tracking method for the operation system 1000 according to another embodiment. In the step S1210, the matching unit 130 deems that the threads T1, T2 belong to the In-Process dependency RS12 of an identical application according to a determination of a relationship between the thread identifications TID1, TID2 and a relationship between the process identifications PID1, PID2.

Next, in the step S1220, the matching unit 130 establishes the In-Process dependency RS12 among the threads T1, T2 and the message queue Q1 according to a determination of a relationship between the input value IP1 of the message queue access event EV1 and the return value RT2 of the message queue access event EV2.

Afterwards, in the step S1230, the matching unit 130 establishes the Inter-Process dependency RS23 according to the Inter-Process Communication IPC1 between the applications A1, A2.

Next, in the step S1240, the matching unit 130 establishes the service execution trace TR according to the In-Process dependencies RS12, RS34 among the threads T1, T2, T3, T4 and the message queues Q1, Q2 and the Inter-Process dependency RS23 between the applications A1, A2. After the service execution trace TR is established, developers can effectively find the root cause of the service abnormality.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A multi-threads tracking method for an operation system, comprising:
intercepting at least two message queue access events among two threads and one message queue;
recording a thread identification, a process identification, an input value and a return value of each of the message queue access events; and
establishing an In-Process dependency among the threads and the message queue according to a determination of a relationship among the thread identifications, the process identifications, the input values and the return values of the message queue access events.

2. The multi-threads tracking method for the operation system according to claim 1, wherein the step of establishing the In-Process dependency among the threads and the message queue comprises:
determining whether the thread identifications of the message queue access events are different and whether the process identifications of the message queue access events are identical; and
deeming that the threads belong to an identical application, if the thread identifications are different and the process identifications are identical.

3. The multi-threads tracking method for the operation system according to claim 1, wherein the step of establishing the In-Process dependency among the threads and the message queue comprises:
determining whether the input value of one of the message queue access events is identical to the return value of another one of the message queue access events; and
establishing the In-Process dependency among the threads and the message queue if the input value of one of the message queue access events is identical to the return value of another one of the message queue access events.

4. The multi-threads tracking method for the operation system according to claim 3, wherein one of the message queue access events is a request for storing a message unit in the message queue, another one of the message queue access events is a request for reading a message unit in the message queue.

5. The multi-threads tracking method for the operation system according to claim 1, further comprising:
intercepting an Inter-Process Communication (IPC) between two applications; and
establishing an Inter-Process dependency between the applications according to the Inter-Process Communication.

6. The multi-threads tracking method for the operation system according to claim 1, further comprising:
deeming that the threads belong to an identical application according to a determination of a relationship between the thread identifications and a relationship between the process identifications;
establishing the In-Process dependency among the threads and the message queue according to a determination of a relationship between an input value of one of the message queue access events and a return value of another one of the message queue access events;
establishing an Inter-Process dependency according to an Inter-Process Communication between two applications; and
establishing a service execution trace according to the In-Process dependency among the threads and the message queue and the Inter-Process dependency between the applications.

7. A multi-threads tracking system for an operation system, comprising:
an intercepting unit, configured to intercept at least two message queue access events among two threads and one message queue;
a recording unit, configured to record a thread identification, a process identification, an input value and a return value of each of the message queue access events; and
a matching unit, configured to establish an In-Process dependency among the threads and the message queue according to a determination of a relationship among the thread identifications, the process identifications, the input values and the return values of the message queue access events.

8. The multi-threads tracking system for the operation system according to claim 7, wherein the matching unit determines whether the thread identifications of the message queue access events are different and whether the process identifications of the message queue access events are identical; and
if the thread identifications are different and the process identifications are identical, the matching unit deems that the threads belong to an identical application.

9. The multi-threads tracking system for the operation system according to claim 7, wherein
the matching unit determines whether the input value of one of the message queue access events is identical to the return value of another one of the message queue access events; and
if the input value of one of the message queue access events is identical to the return value of another one of the message queue access events, the matching unit establishes the In-Process dependency among the threads and the message queue.

10. The multi-threads tracking system for the operation system according to claim 9, wherein one of the message queue access events is a request for storing a message unit in the message queue, another one of the message queue access events is a request for reading a message unit in the message queue.

11. The multi-threads tracking system for the operation system according to claim 7, wherein
the intercepting unit is further configured to intercept an Inter-Process Communication (IPC) between two applications; and
the matching unit establishes an Inter-Process dependency between the applications according to the Inter-Process Communication.

12. The multi-threads tracking system for the operation system according to claim 7, wherein
the matching unit deems that the threads belong to an identical application according to a determination of a relationship between the thread identifications and a relationship between the process identifications;
the matching unit establishes the In-Process dependency among the threads and the message queue according to a determination of a relationship between an input value of one of the message queue access events and a return value of another one of the message queue access events;
the matching unit establishes an Inter-Process dependency according to an Inter-Process Communication between two applications; and
the matching unit establishes a service execution trace according to the In-Process dependency among the threads and the message queue and the Inter-Process dependency between the applications.

13. An electronic device, comprising a processor, wherein the processor is configured to load a program code for performing a multi-threads tracking method for an operation system, and the multi-threads tracking method comprises:
intercepting at least two message queue access events among two threads and one message queue;
recording a thread identification, a process identification, an input value and a return value of each of the message queue access events; and
establishing an In-Process dependency among the threads and the message queue according to a determination of a relationship among the thread identifications, the process identifications, the input values and the return values of the message queue access events.

14. The electronic device according to claim 13, wherein the establishing the In-Process dependency among the threads and the message queue comprises:
determining whether the thread identifications of the message queue access events are different and whether the process identifications of the message queue access events are identical; and
deeming that the threads belong to an identical application, if the thread identifications are different and the process identifications are identical.

15. The electronic device according to claim 13, wherein the step of establishing the In-Process dependency among the threads and the message queue comprises:
determining whether the input value of one of the message queue access events is identical to the return value of another one of the message queue access events; and
establishing the In-Process dependency among the threads and the message queue if the input value of one of the message queue access events is identical to the return value of another one of the message queue access events.

16. The electronic device according to claim 15, wherein one of the message queue access events is a request for storing a message unit in the message queue, another one of the message queue access events is a request for reading a message unit in the message queue.

17. The electronic device according to claim 13, wherein the multi-threads tracking method further comprises:
intercepting an Inter-Process Communication (IPC) between two applications; and
establishing an Inter-Process dependency between the applications according to the Inter-Process Communication.

18. The electronic device according to claim 13, wherein the multi-threads tracking method further comprises:
deeming that the threads belong to an identical application according to a determination of a relationship between the thread identifications and a relationship between the process identifications;
establishing the In-Process dependency among the threads and the message queue according to a determination of a relationship between an input value of one of the message queue access events and a return value of another one of the message queue access events;
establishing an Inter-Process dependency according to an Inter-Process Communication between two applications; and
establishing a service execution trace according to the In-Process dependency among the threads and the message queue and the Inter-Process dependency between the applications.
